(19) United States
(12) Patent Application Publication
(10) Pub. No.: US 2024/0003335 A1
(43) Pub. Date: Jan. 4, 2024

(54) MOUNTING ADAPTER FOR MOUNTING ROTOR BLADES TO A WIND TURBINE AND METHOD FOR MOUNTING ROTOR BLADES TO A WIND TURBINE

(71) Applicant: Wobben Properties GmbH, Aurich (DE)

(72) Inventors: Günter Fleßner, Aurich (DE); Stephan Siebelts, Holtgast (DE); Dirk Ressel, Aurich (DE)

(21) Appl. No.: 18/345,740

(22) Filed: Jun. 30, 2023

(30) Foreign Application Priority Data
Jul. 4, 2022 (EP) 22182818.9

(51) Int. Cl. F03D 13/10

(52) U.S. Cl. CPC F03D 13/10; F05B 2230/61

(57) ABSTRACT

A mounting adapter for mounting rotor blades of a wind turbine is provided. The mounting adapter has a first flange unit with a first flange surface, which is suitable for being fastened to a rotor blade connection of a wind turbine. The mounting adapter has a second flange unit with a second flange surface, which is suitable for having a rotor blade of the wind turbine fastened to it. The first and second flange units can be swiveled around a swivel axis relative to each other. An angle spanned by the first and second flange surfaces can be varied, so as to ensure at least a first and second operating position of the mounting adapter with different angles.

### BACKGROUND

### Technical Field

The present invention relates to a mounting adapter for mounting rotor blades to a wind turbine and a method for mounting rotor blades to a wind turbine.

### Description of the Related Art

Installing a wind turbine requires a crane with a corresponding hook height, so that the nacelle, the generator, and the rotor blades can be mounted. As the hub height increases, the hook height (i.e., the maximum height of the hook) must also be enlarged. However, this is not arbitrarily possible, since cranes with a corresponding hook height are not arbitrarily available.

WO 2020/187959 A1 describes a method for mounting rotor blades of a wind turbine. By intelligently turning the rotor hub, an attempt is here made to simplify the mounting of rotor blades, and in particular to reduce the crane height required for this purpose.

### BRIEF SUMMARY

Provided is a method for mounting rotor blades to a wind turbine, which enables a simplified design at larger hub heights. Provided are techniques that enable a reduced hook height of a crane while mounting rotor blades of a wind turbine. According to an aspect of the present disclosure, a mounting adapter used for mounting a rotor blade can be configured as an articulated hinged adapter. During the mounting process, the adapter is provided on one of the three rotor blade connections on the hub. The adapter has a first and a second flange surface. The first flange surface can be mounted on a rotor blade connection. The rotor blade is mounted to the second flange surface. The first and second flange surfaces are connected with each other via a swivel axis. As a consequence, the angle between the first and second flange surface can be varied. In particular, an adapter can here be provided which has at least two operating positions with different angles between the first and second flange surface.

As an option, the angle can measure 30° in a first operating position, and 60° in a second operating position.

According to an aspect of the present disclosure, the adapter has two operating positions with two different angles between the first and second flange surface.

According to another aspect of the present disclosure, the adapter has at least three operating positions, wherein the first and second operating positions each have a first and second angle between the first and second flange surface. In the third operating position, the first and second flange surface can be arranged parallel to each other.

According to an aspect of the present disclosure, an adapter has a first and second unit or flange unit, which are swivelably connected with each other. The first and the second flange units each have a flange surface and two parallel side walls, which each are connected with the flange surface. Holes or bores can be provided in the side walls.

According to an aspect of the disclosure, the mounting adapter has a mounting arm, which extends beyond the first and second flange surface.

According to a first aspect, the first flange unit can have a flange surface and two side walls, wherein the side walls each can have two bores with a varying distance to the flange surface. The second flange unit can likewise have a flange surface and two side walls. The side walls of the second flange unit can each have at least three openings or bores. It is here possible to provide a bore at a first end of the side walls, and two bores with a varying distance to the flange surface at a second end of the side walls. For example, the one bore at one end of the side walls of the second flange unit and a first bore in the side walls of the first flange unit can be connected with each other by means of a bolt, so that the bolt functions as a hinge, and the first and second flange surface can be swiveled, so that the angle between the first and second flange surface is variable. In order to lock the first and second flange unit in place, a bolt can be provided in the respective second hole of the side wall of the first flange unit, as well as in one of the two free holes in the side walls of the second flange unit. The angle between the first and second flange surface can be adjusted via the selection of the second holes. The adapter preferably has at least two operating positions, which are realized by the two holes or bores at the second end of the side walls of the second flange surface.

According to another aspect of the present disclosure, the first or second flange unit can have a flange surface and two side walls, wherein the side walls have four holes. Two holes can here be provided at the first end with a varying distance to the flange surface. A respective two additional holes can be provided at the second end of the side wall, which likewise can be provided with a varying distance to the flange surface. As a consequence, the side walls can each have four openings or bores. The side walls of the other flange unit can have two holes, each at the first and second end of the respective side wall. Such an adapter can be used to achieve at least three different operating positions. Two different angles between the first and second flange surface can here be realized. An adapter with parallel flange surfaces can be provided in a third operating point.

According to an aspect of the disclosure, the adapter can have two swivelable (mutually swivelable) flange units, each with a flange surface. The angle between the two flange surfaces is adjustable, and can have at least two angles.

Provided is a method for mounting rotor blades to a wind turbine. The wind turbine has a hub with three rotor blade connections for receiving rotor blades and a tower longitudinal axis. A mounting adapter described above is mounted to one of the rotor blade connections. The hub is turned, so that one of the three rotor blade connections is located in a 3 o'clock position or at an angle of 90° relative to the tower longitudinal axis. A first rotor blade is lifted at this rotor blade connection and mounted there. The mounting adapter is here in a first operating position with a first angle between its first and second flange surfaces. A second rotor blade is mounted to a second of the three rotor blade connections. A third rotor blade is mounted to the second flange surface of the mounting adapter. The angle between the first and second flange surface is changed, so that the mounting adapter is in a second operating position. The third rotor blade is disassembled, and the mounting adapter is mounted. The third rotor blade is subsequently mounted to the third rotor blade connection.

According to an aspect of the disclosure, the hub is turned in such a way that the second flange surface of the mounting adapter is located parallel to the tower longitudinal axis before the third rotor blade can be mounted. The third rotor blade is subsequently mounted to the second flange surface. The hub is turned clockwise, and the operating position of the mounting adapter is changed. The hub is turned clockwise by 30°. The third rotor blade is disassembled. The mounting adapter is disassembled, and the third rotor blade is mounted to the third rotor blade connection.

According to another aspect of the present disclosure, the second rotor blade is mounted to the second flange surface of the mounting adapter, which is provided parallel to the tower longitudinal axis. The operating position of the mounting adapter is changed, and the hub is turned clockwise. The operating position of the mounting adapter is changed in such a way that the first and second flange surfaces are arranged essentially parallel to each other, and the third rotor blade is fastened to the second flange surface and arranged essentially horizontally. The rotor blade is disassembled, the mounting adapter is disassembled, and the rotor blade is mounted to the third rotor blade connection.

Additional configurations of the invention are the subject of the subclaims.

### BRIEF DESCRIPTION OF THE SEVERAL VIEWS OF THE DRAWINGS

Advantages and exemplary embodiments of the invention will be explained in more detail below with reference to the drawing.

FIG. 1 shows a wind turbine according to an aspect of the invention,

FIGS. 2A and 2B each show a view of a mounting adapter for mounting rotor blades of a wind turbine according to a first exemplary embodiment,

FIG. 3A to 3M show various steps for mounting rotor blades of a wind turbine according to a first exemplary embodiment,

FIG. 4A to 4C each show a view of a mounting adapter according to a second exemplary embodiment, and

FIG. 5A to 5K each show a step in the process of mounting rotor blades of a wind turbine according to a second exemplary embodiment.

### DETAILED DESCRIPTION

A tower longitudinal axis 102a can assume a 0° or a 12 o'clock position. In this way, the positions of the rotor blade connections can be allocated to an angle (0° to 360°) or a “time of day” (12 o'clock to 11 o'clock).

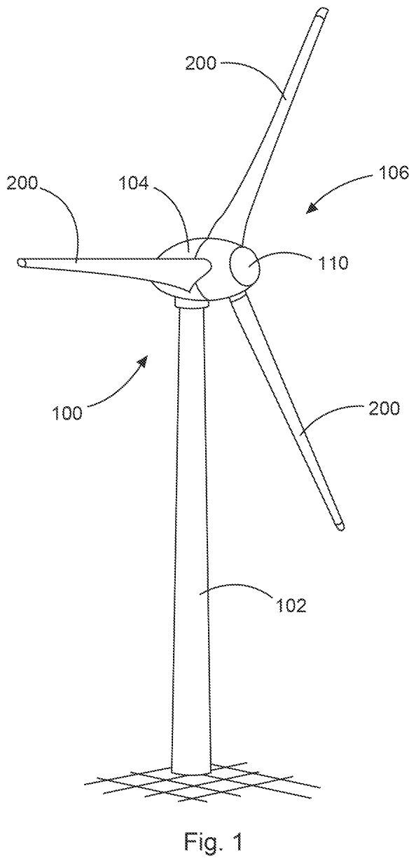

FIG. 1 shows a schematic view of a wind turbine according to the invention. The wind turbine 100 has a tower 102 and a nacelle 104 on the tower 102. An aerodynamic rotor 106 with three rotor blades 200 and a spinner 110 is provided on the nacelle 104. During operation of the wind turbine, the aerodynamic rotor 106 is made to rotate by the wind, and thereby also turns a rotor or runner of a generator, which is directly or indirectly coupled with the aerodynamic rotor 106. The electric generator is arranged in the nacelle 104, and generates electric energy. The pitch angles of the rotor blades 200 can be changed by pitch motors on the rotor blade roots of the respective rotor blades 200.

Positions of the aerodynamic rotor 106 as well as the rotor blade connections 121, 122, 123 can be described using a clock face or based on angle information. 0° here corresponds to a 12 o'clock position, and can be determined by a tower longitudinal axis, for example. 90° corresponds to a 3 o'clock position, 180° corresponds to a 6 o'clock position, and 270° corresponds to a 9 o'clock position.

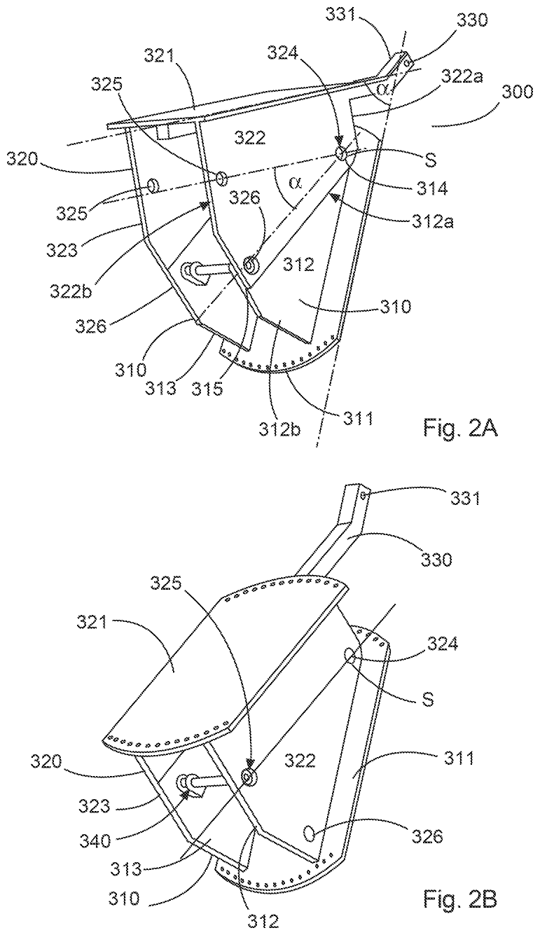

FIGS. 2A and 2B each show a view of the mounting adapter for mounting rotor blades of a wind turbine according to a first exemplary embodiment. An adapter or a mounting adapter 300 according to the first exemplary embodiment has two flange units 310, 320, which are designed so that they can swivel relative to each other, i.e., the angle α between the first and second flange unit 310, 320 can be varied.

The first flange unit 310 has a first flange surface 311 as well as two first side walls 312, 313. The first two side walls 312, 313 each have a first and second end 312a, 312b, 313a, 313b. A respective first hole or bore 314 is provided at the first end 312a, 313a, and a respective second hole or bore 315 is provided at the second end 312b. The first hole 314 has a first distance 314a to the first flange surface, and the second hole 315 has a second distance 315a to the first flange surface 311. The first distance 314a is here significantly smaller than the second distance 315a.

The second flange unit 320 has a second flange surface 321 as well as two side walls 322, 323, which are connected with the second flange surface 321. The second side walls each have a first and second end 322a, 322b; 323a, 323b and further have at least three holes or bores 324, 325, 326. The first hole 324 of the first side wall 322 of the second flange unit 320 is provided at a first end 322a, and the second and third holes 325, 326 are provided at the second end 322b of the second side walls 322, 323. The second and third holes 325, 326 have varying distances 325a, 326a to the second flange surface 321.

According to an aspect of the present disclosure, the first holes 324 of the second side walls 322, 323 and the first hole 314 of the first side wall of the first flange unit 310 receive a bolt 341 or the like, for example, so that this location serves as a hinge of the adapter unit 300, and forms a swivel axis S.

A (mounting) arm 330 with a suspension point 331 can optionally be provided on the first or second flange unit 310, 320, and in particular on the first or second flange surface 311. 321. The suspension point 331 is used to be able to transport (lift or lower) the adapter 300 with a crane hook.

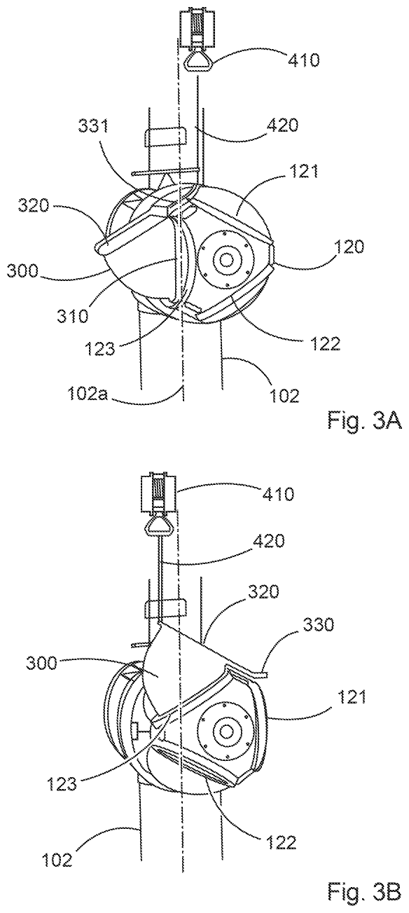

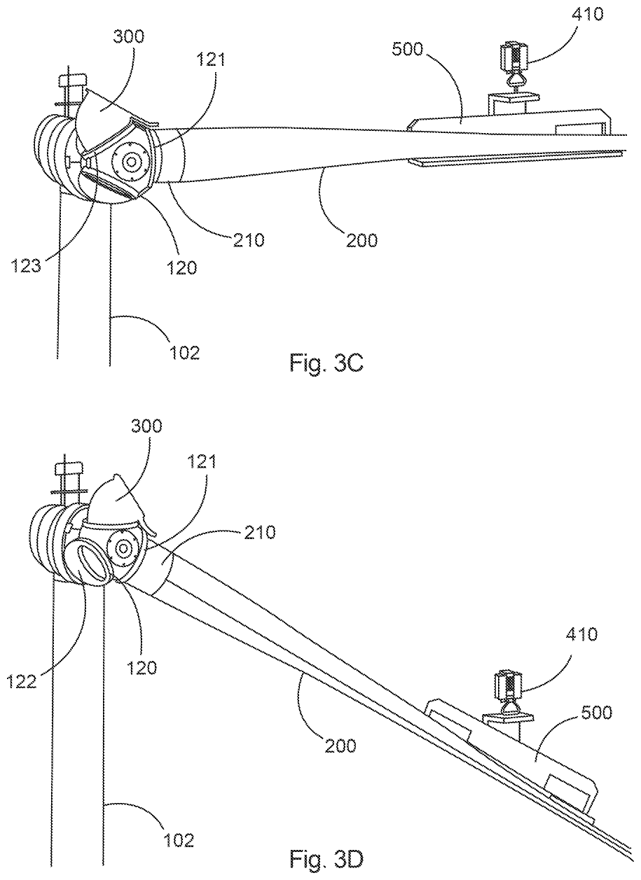

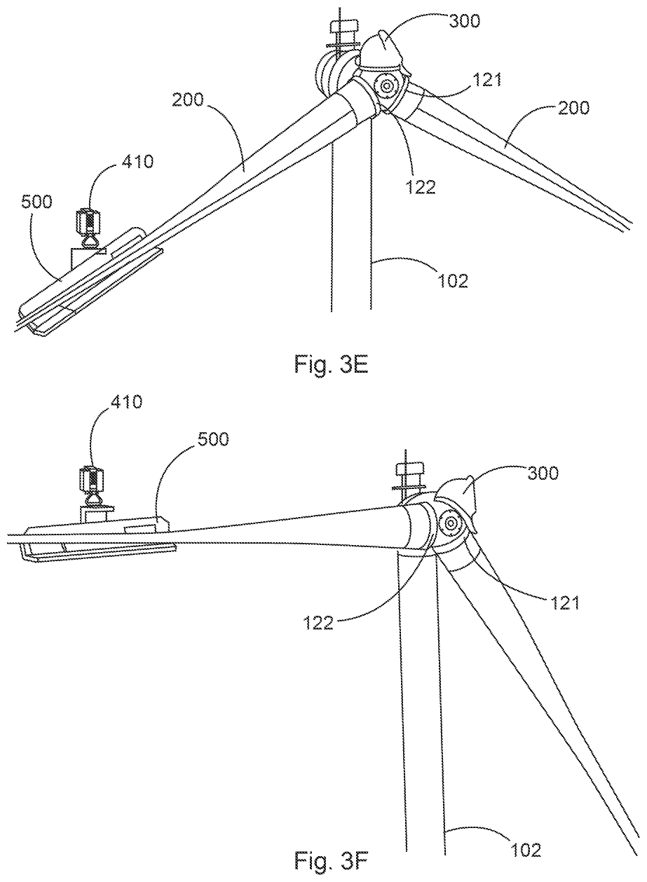

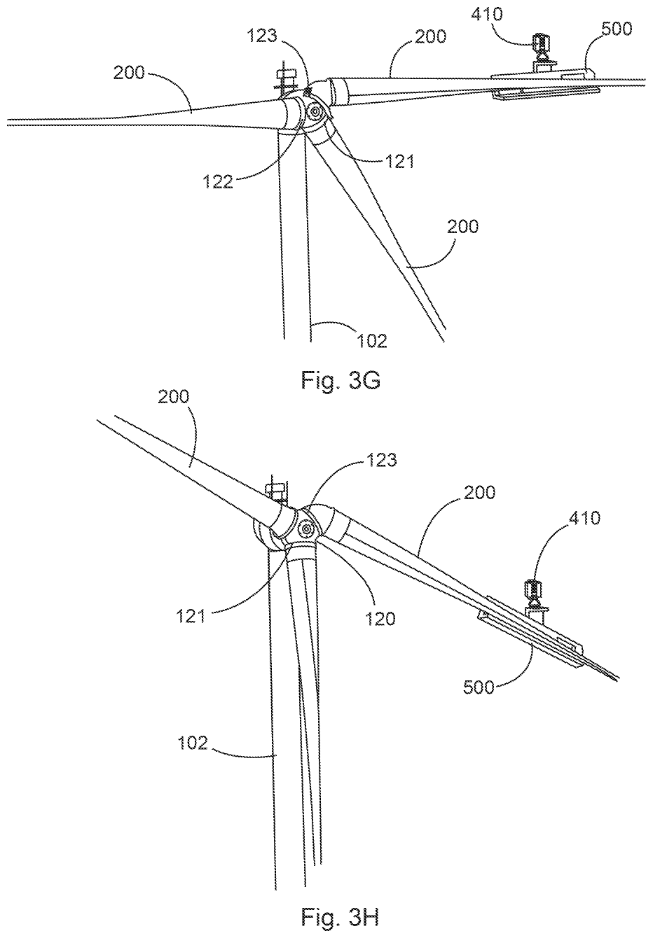

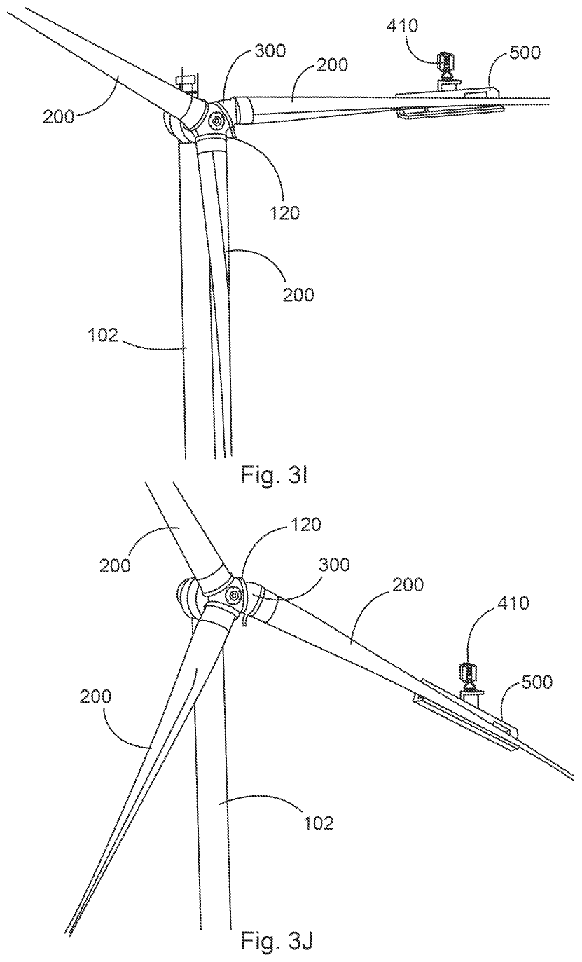

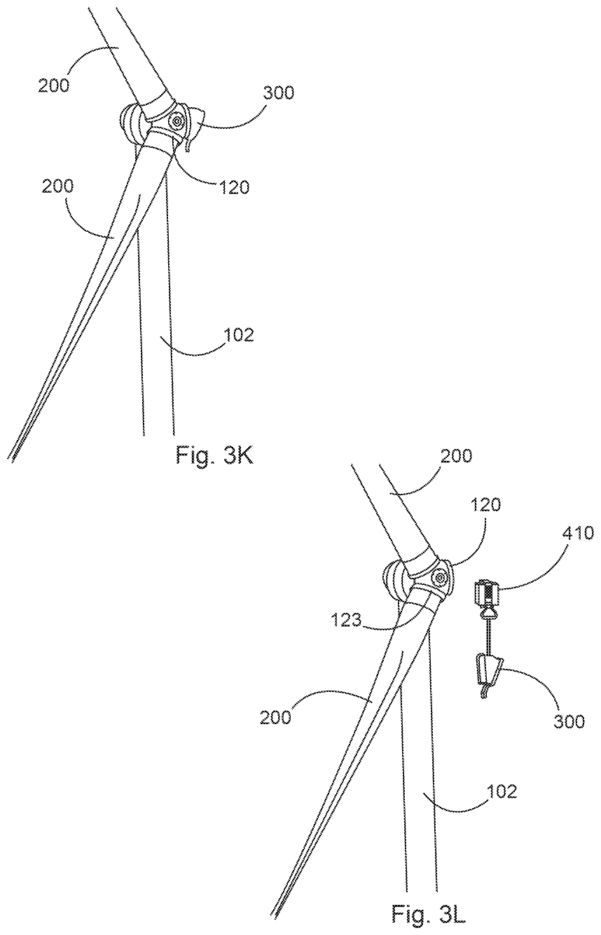

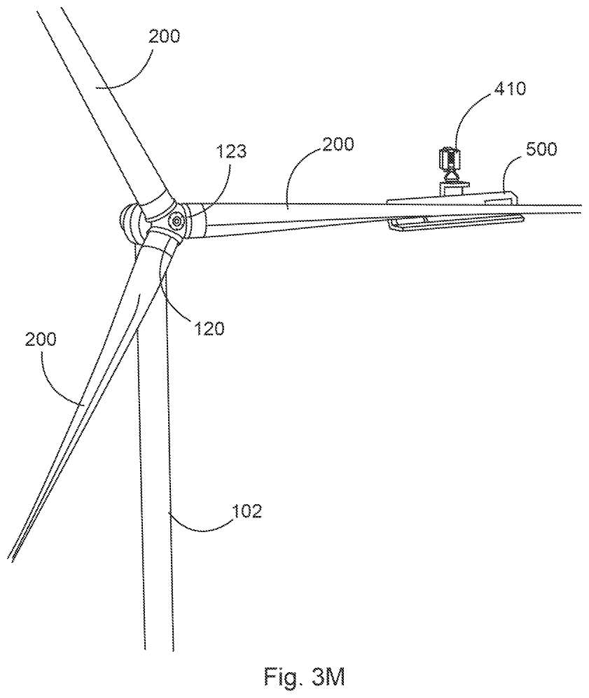

FIG. 3A to 3M show various steps for mounting rotor blades of a wind turbine according to the first exemplary embodiment. In the first step (see FIG. 3A), a hub 120 of the wind turbine is mounted with three rotor blade connections 121, 122, 123 by means of a crane hook 410 and a sling or a rope 420. A mounting adapter 300 can here already be mounted to a rotor blade connection 121-123. For example, the hub can be mounted by means of the mounting arm 330 and the crane hook 410. The hub can subsequently (see FIG. 3B) be turned clockwise by 60°, so that the first rotor blade connection 121 is located in a 3 o'clock position or at an angle of 90° relative to a tower longitudinal axis.

A first blade 200 is subsequently (see FIG. 3C) mounted to the first rotor blade connection 121, for example by means of a blade traverse 500. The rotor blade 200 is here mounted essentially horizontally. In the next step (see FIG. 3D), the first rotor blade 200 is moved downwards clockwise by 30°. A second rotor blade 200 is subsequently (see FIG. 3E) mounted to the second rotor blade connection 122. The second rotor blade connection 122 is here located in an 8 o'clock position. The second rotor blade can be mounted by means of a lifting traverse 500, and optionally be mounted at an angle of 30° relative to the horizontal. In the next step (se FIG. 3F), the second rotor blade 200 is pulled upwards by 30°, so that the second rotor blade connection 122 is located in a 9 o'clock position (270°). The rotor blade 200 is thus essentially horizontal. In the next step (FIG. 3G), the third rotor blade 200 is mounted to the mounting adapter 300. During the mounting process, the rotor blade 200 is located essentially in the horizontal plane. In the next step (FIG. 3H), the third rotor blade is twisted downwards clockwise by 30°. In the next step (FIG. 3I), the adapter 300 is moved into another operating position. For example, this can be done by opening the respective bolts, so that the angle between the first and second flange surface is changed. The third blade 200 is then pulled upwards counterclockwise by 30°. In the next step (FIG. 3J), the bolts on the adapter 300 are closed, and the adapter 300 is then located in another operating position. The third rotor blade can subsequently again be turned clockwise by 30°. In the next step (FIG. 3K), the third rotor blade is conveyed downwards by means of the rotor blade traverse, and the adapter is disassembled by means of a crane hook (see FIG. 3L). The rotor blade can subsequently again be mounted by means of the rotor blade traverse to the third rotor blade connection, which is located in the 3 o'clock position or at 90°.

According to an aspect of the present disclosure, the rotor blades 200 of a wind turbine are mounted with the help of a mounting adapter 300, which is mounted to a rotor blade connection 121-123. The mounting adapter 300 has a first and second flange surface 311, 321, which are arranged at an angle relative to each other. The angle between the first and second flange surfaces 311, 321 can optionally be adjusted. The mounting adapter optionally has at least two operating positions with varying angles between the first and second flange surfaces. The mounting adapter optionally has a mounting arm 330 with a bore 331. The mounting arm can be used to lift or lower the mounting adapter by means of the crane hook 410.

According to an aspect of the present disclosure, the mounting adapter 300 can be mounted to a rotor blade connection 121-123 of the hub of the wind turbine 100 before mounting the hub. In particular, the hub can here be lifted and mounted to or in the nacelle by means of the mounting arm 330.

According to an aspect of the present disclosure, the mounting arm 330 is mounted to a first end of the mounting adapter 300. At least one additional bore can be provided at a second end of the mounting adapter in the area of the first and/or second flange surface. This bore and a rope 420 can be used to disassemble the mounting adapter. Alternatively thereto, the second bore can also be used to turn the hub. As shown on FIG. 3B, a rope 420 can here be fastened to a crane hook 410, so that the hub 120 is turned clockwise by 60° by means of the crane hook 410, for example, so that the first rotor blade connection 121 is located in a 3 o'clock position or 90° position, and the first rotor blade 200 can be horizontally mounted.

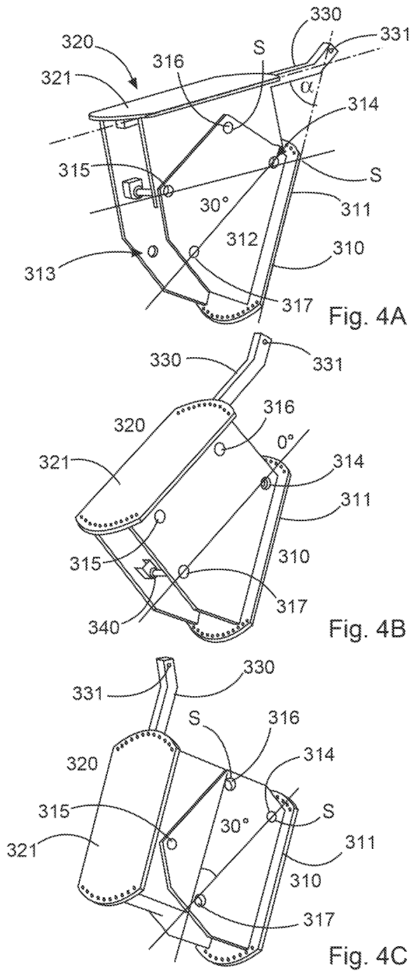

FIG. 4A to 4C each show a view of the mounting adapter 300 according to a second exemplary embodiment. For example, the mounting adapter 300 according to the second exemplary embodiment can be configured as a double-joint adapter. As in the first exemplary embodiment, the mounting adapter 300 has a first and second flange unit 310, 320. The first flange unit 310 has a flange surface 311 as well as two side walls 312, 313, which are connected with the flange surface 310. The second flange unit 320 has a second flange surface 321 as well as two side walls 322, 323, which are coupled with the flange surface 311. The side walls 312, 313 of the first flange unit 310 as well as the side walls 322, 323 of the second flange unit 320 can optionally be configured parallel to each other. The distance between the side surfaces 312, 313 of the second flange unit 320 can optionally be smaller than the distance between the side surfaces of the first flange unit 310.

The side surface 312, 313 of the first flange unit 310 can have four holes or bores 314, 315, 316, 317. It is here possible to provide two holes or bores 314, 316 at the first end, as well as two holes 315, 317 at the second end of the side walls. The holes 314, 316 can serve to receive a pivot bolt, so as to form a hinge of the mounting adapter 300, so that the first and second flange units 310, 320 can be swiveled relative to each other around a swivel axis S, so that the angle α between the first flange surface 311 and the second flange surface 321 can be adjusted. The two holes 315, 317 can be used to receive a locking bolt or arresting bolt 340. The locking bolt or arresting bolt 340 can thus optionally be received in the opening or bore 315 or in the opening or bore 317. This makes it possible to realize two different operating positions (with a varying angle α between the first and second flange surface 311, 321).

On FIG. 4A, the arresting bolt 340 is arrested in the opening 315. On FIG. 4B, the arresting bolt 340 is arrested in the opening 317. As a consequence, a different angle α is present between the first and second flange surface 311, 321 than on FIG. 4A. The difference between the mounting adapter on FIG. 4A and the mounting adapter on FIG. 4B lies solely in the fact that the locking bolt 340 is arrested in a different hole at the second end of the side walls.

FIG. 4C shows the mounting adapter in an unfolded state. The second flange unit 320 or the side walls of the second flange unit are here coupled by corresponding bolts with the holes or bores 317, 316 of the side walls of the first flange unit 310. The first and second flange surfaces 311, 321 can thus be configured parallel to each other.

According to the second exemplary embodiment, a mounting arm 330 is fastened to the second flange unit 320. The mounting arm 330 can be kinked in design, and have a bore 331 at the free end. This bore 331 can be used to lift or lower the mounting adapter by means of a rope and a crane hook.

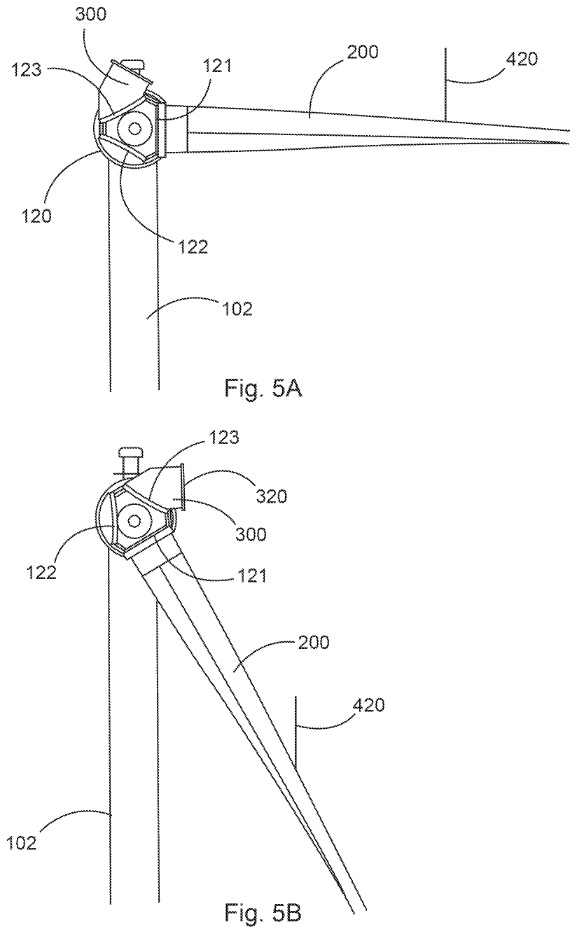

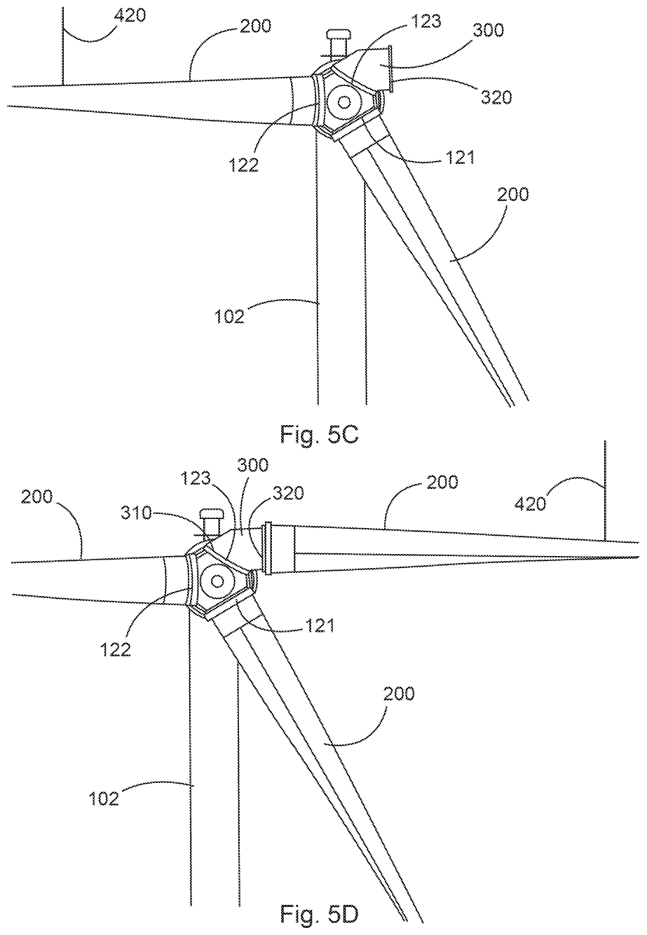

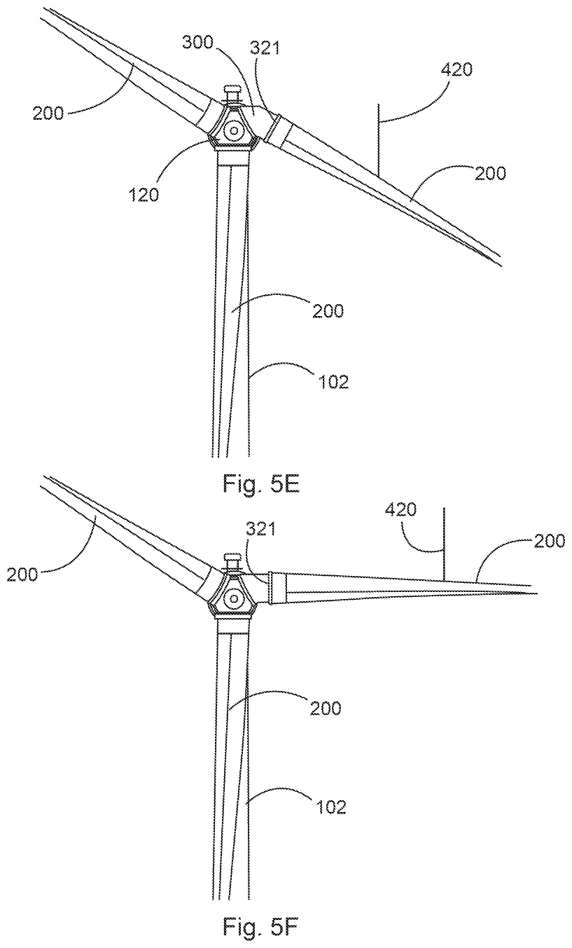

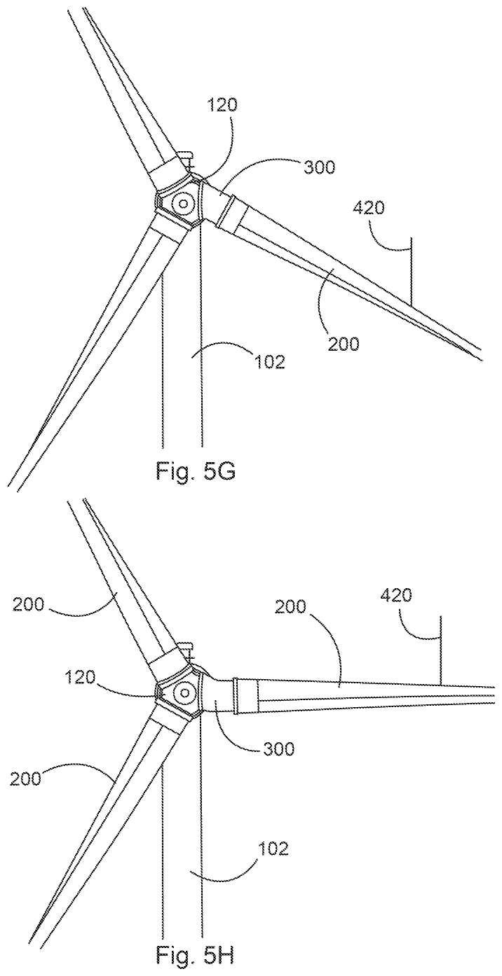

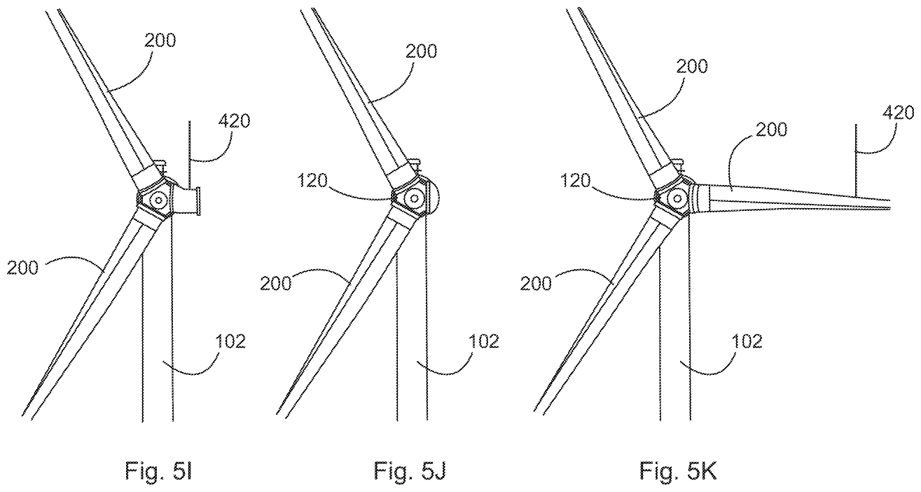

FIG. 5A to 5K each show a step during the process of mounting rotor blades of a wind turbine according to a second exemplary embodiment. FIG. 5A shows a first rotor blade 200 already mounted to a first rotor blade connection 121. The mounting adapter 300 is provided on the third rotor blade connection 123. As shown on FIGS. 3A and 3B, the mounting adapter 300 can optionally also be mounted to one of the rotor blade connections 121-123 of a hub 120 according to the second exemplary embodiment, before the hub along with the mounting adapter 300 are pulled upwards by means of a crane hook. The hub can optionally be pulled upwards by means of the mounting adapter 300 mounted to a rotor blade connection (as shown on FIG. 3A). As shown on FIG. 3B, the hub can subsequently be turned clockwise by 60° by means of the mounting adapter 300 on the third rotor blade connection 123, by means of a rope 420 as well as a crane hook 410, so that the first rotor blade connection 121 is located in the 3 o'clock position or the 90° position. On FIG. 5A, the rotor blade 200 is already mounted to the first rotor blade connection 121. The rotor blade 200 is preferably pulled horizontally upwards, and mounted to the first rotor blade connection 121.

According to the second exemplary embodiment, the rotor blades can optionally be mounted without a lifting traverse 500 (as shown in the first exemplary embodiment).

As shown on FIG. 5B, the rotor blade 200 is lowered downwards by 60°, so that the hub 120 turns clockwise by 60°. As a consequence, the second rotor blade connection 122 is located in a 9 o'clock position or in a 270° position. As shown on FIG. 5C, the second rotor blade 200 can be pulled horizontally upwards, and mounted to the second rotor blade connection 122. The mounting adapter 300 is fastened to the third rotor blade connection 123. In particular, the first flange surface 310 can be fastened to the second rotor blade connection 122. For example, the second flange surface 320 can here be provided on the second rotor blade connection 122 essentially perpendicular in relation to the second rotor blade 200, so that the third rotor blade can be horizontally mounted to the second flange surface 320. As a consequence, both the second rotor blade 200 and the third rotor blade 200 can be horizontally mounted without the rotor hub 120 here having to be turned.

As shown on FIG. 5E, the hub 120 is turned clockwise by 30° by lowering the third rotor blade 200. The rotor hub 120 is then arrested (bolted), and the third rotor blade is lifted by 30°. The lock between the first and second flange units 310, 320 is here undone, so that the angle between the first and second flange units 310, 320 changes, so that the second flange surface 321 is configured essentially perpendicular to the tower longitudinal axis. Therefore, the third rotor blade 300 is then also essentially horizontally aligned. As shown on FIG. 5G, the third rotor blade 200 is lowered downwards by 30°, and the rotor hub 120 is bolted. As shown on FIG. 5H, the third rotor blade is subsequently lifted again by 30°, and the rotor is bolted. The third rotor blade 200 is then removed from the mounting adapter 300. The rotor blade can optionally be conveyed downwards, and there put down. The mounting adapter is then lowered by means of a crane hook, and the rotor blade can again be essentially horizontally lifted and mounted to the third rotor blade connection 123. As a consequence, all three rotor blades are then mounted to the rotor hub.

According to an aspect of the present disclosure, the crane used for mounting the nacelle can thus also be used for mounting the rotor blades. As a result, it is sufficient that a crane be present at the construction site.

The rotor blades are mounted either horizontally or at −30°.

According to an aspect of the present disclosure, the mounting adapter has a first and second flange unit, which are configured so that they can be swiveled or turned relative to each other. The angle between the first and second flange unit can here measure 30° or 60°, for example. Alternatively thereto, the mounting adapter can have an operating position in which the first and second flange units are configured parallel to each other.

According to an aspect of the present disclosure, the method described above can be used for mounting rotor blades of a wind turbine, in particular given a tower height of >160 m.

According to an aspect of the present disclosure, a mounting adapter is provided for mounting wind turbine rotor blades. The mounting adapter has a first and second flange unit 310, 320, which are configured so that they can swivel relative to each other. The first and second flange units 310, 320 can here assume at least two operating positions, wherein each operating position causes or has a different angle between the first and second flange units.

A first flange surface can be used to mount the mounting unit to a rotor blade connection of a wind turbine. A second rotor blade connection can be used for mounting a rotor blade root, and hence a rotor blade. As a consequence, the mounting adapter is provided between the rotor blade and a rotor blade connection (while mounting the rotor blades). In particular, while mounting the three rotor blades, the mounting adapter is fastened to one of the three rotor blade connections and again removed after mounting the rotor blades.

### REFERENCE LIST

100 Wind turbine
102 Tower
102a Tower longitudinal axis
104 Nacelle
106 Rotor
110 Spinner
120 Hub
121 Rotor blade connection
122 Rotor blade connection
123 Rotor blade connection
200 Rotor blades
300 Mounting adapter
310 Flange units
311 Flange surface
312 Side walls
312a First end
312b Second end
313 Side walls
313a First end
313b Second end
314 Bore
314a First distance
315 Bore
315a Second distance
316 Bores
317 Bores
320 Flange units
321 Flange surface
322 Side walls
322a First end
322b Second end
323 Side walls
324 Bores
325 Bores
325a Distance
326 Bores
326a Distance
330 (Mounting) arm
331 Suspension point
341 Bolt
340 Arresting bolt
410 Crane hook
420 Rope
500 Blade traverse
S Swivel axis

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A mounting adapter for mounting rotor blades of a wind turbine, the mounting adapter comprising:
a first flange unit with a first flange surface, wherein the first flange surface is suitable for being fastened to a rotor blade connection, and
a second flange unit with a second flange surface, wherein the second flange surface is suitable for having a rotor blade of the wind turbine fastened thereto,
wherein the first and second flange units are configured to be swiveled around a swivel axis relative to each other, and
wherein an angle spanned by the first and second flange surfaces is configured to be varied to ensure at least a first operating position and a second operating position of the mounting adapter with different angles.

2. The mounting adapter according to claim 1, wherein:
the first flange unit has two first side walls, wherein each of the two first side walls are connected with the first flange surface,
the second flange unit has two second side walls, wherein each of the two second side walls are connected with the second flange surface, and
wherein the first and second side walls have openings in which a bolt is configured be position to set one of the at least two operating positions with different angles.

3. The mounting adapter according to claim 1, further comprising a mounting arm connected with the first or second flange surfaces, wherein the mounting arm extends over the first or second flange surfaces on one side.

4. The mounting adapter according to claim 2, the first or second side walls have openings with a varying distance to the first or second flange surfaces so that different operating positions of the mounting adapter can be set.

5. The mounting adapter according to claim 1, wherein the angle measures 30° in the first operating position, and 60° in the second operating position.

6. A method for mounting rotor blades to a wind turbine, wherein the wind turbine has a hub with first, second and third rotor blade connections for receiving rotor blades and a tower longitudinal axis, the method comprising:
mounting the mounting adapter according to claim 1 to the third rotor blade connection,
turning the hub, so that the first rotor blade connection is located in a 3 o'clock position or at an angle of 90° relative to the tower longitudinal axis,
lifting and mounting a first rotor blade to the first rotor blade connection,
wherein the mounting adapter is located in a first operating position with a first angle between the first and second flange surfaces,
mounting a second rotor blade to the second rotor blade connection,
mounting a third rotor blade to the second flange surface of the mounting adapter,
changing the angle between the first and second flange surfaces, so that the mounting adapter is located in a second operating position,
disassembling the third rotor blade from the second flange surface,
disassembling the mounting adapter from the third rotor blade connection, and
mounting the third rotor blade to the third rotor blade connection.

7. The method according to claim 6, further comprising:
turning the hub so that the second flange surface is located parallel to the tower longitudinal axis before the third rotor blade is mounted,
mounting the third rotor blade to the second flange surface,
turning the hub clockwise,
changing the operating position of the mounting adapter,
turning the hub clockwise by 30°,
disassembling the third rotor blade,
disassembling the mounting adapter, and
mounting the third rotor blade to the third rotor blade connection.

8. The method according to claim 6, further comprising:
mounting the second rotor blade to a second flange surface of the mounting adapter, which is provided parallel to the tower longitudinal axis,
changing the operating position of the mounting adapter,
turning the hub clockwise,
changing the operating position of the mounting adapter so that the first and second flange surfaces are essentially arranged parallel, and the third rotor blade is fastened to the second flange surface and essentially arranged horizontally,
disassembling the third rotor blade from the second flange surface,
disassembling the mounting adapter, and
mounting the third rotor blade to the third rotor blade connection.
